(19) United States
(12) Patent Application Publication
(10) Pub. No.: US 2020/0040887 A1
(43) Pub. Date: Feb. 6, 2020

(54) PUMP, AND A METHOD FOR ITS OPERATION, AND FOR DETERMINING A TOP AND/OR BOTTOM DEAD CENTER

(71) Applicant: Robert Bosch GmbH, Stuttgart (DE)

(72) Inventors: Arno Matzner, Kornwestheim (DE); Kathrin Schaefer, Ostfildern (DE); Marc Kovacic, Owen (DE); Sebastian Gepperth, Stuttgart (DE); Siegfried Zerbin, Hinterlintal (DE)

(21) Appl. No.: 16/528,782

(22) Filed: Aug. 1, 2019

(30) Foreign Application Priority Data
Aug. 3, 2018 (DE) 10 2018 212 985.1

(51) Int. Cl. F04B 49/06; F04B 43/04; G01H 3/10; G01D 5/26; G01D 5/14; G01D 5/16

(52) U.S. Cl. CPC F04B 49/06; F04B 43/04; G01D 5/16; G01D 5/26; G01D 5/142; G01H 3/10

(57) ABSTRACT

A pump, which has a diaphragm pump module (10) with at least one sensor, which is fitted so as to detect the arrival at a top and/or bottom dead center of the diaphragm pump module (10). Also a method for determining the top and/or bottom dead center.

### BACKGROUND OF THE INVENTION

The present invention concerns a pump that is embodied as a diaphragm pump. The present invention moreover concerns a method for determining a top and/or bottom dead center of a diaphragm pump module of the pump. The present invention also concerns a method for operating the pump. Furthermore, the present invention concerns a computer program, which executes each step of at least one of the methods, together with a machine-readable storage medium, which stores the computer program. Finally, the invention concerns an electronic control unit, which is equipped so as to execute the methods.

In order to comply with ever-stricter exhaust gas legislation, it is necessary to reduce the nitrogen oxides in the exhaust gas of internal combustion engines, in particular diesel engines. To this end it is of known for an SCR (selective catalytic reduction) catalyst to be arranged in the exhaust gas system to reduce the nitrogen oxides, contained in the exhaust gas of the internal combustion engine, to nitrogen in the presence of a reducing agent. By this means the proportion of nitrogen oxides in the exhaust gas can be significantly reduced. Ammonia is required for the progress of the reaction, and this is added to the exhaust gas. As a rule, an aqueous urea solution (diesel exhaust fluid (DEF)) is used, which is injected into the gas system upstream of the SCR catalyst and acts as an ammonia-separating reagent. A 32.5% aqueous urea solution is commercially available under the brand name AdBlue®.

Since the freezing point of AdBlue® is −11.5° C., at winter temperatures it is necessary to pump the DEF back from a metering module into a reducing agent tank after switching off the internal combustion engine, in order to prevent damage to the metering module if the DEF freezes. If a diaphragm pump is used as a delivery pump for the DEF, however, a pumping process is only possible in the delivery direction. One solution to this problem is to provide a separate return pump. Alternatively, a valve system can also be provided, which makes it possible to direct the flow of the DEF in either the delivery direction or the return direction. However, such valve systems can lead to leakages, the result of which can be a pressure loss and the occurrence of corrosive DEF.

### SUMMARY OF THE INVENTION

The invention is based on the knowledge that it is possible to direct the liquid flow of a unidirectional diaphragm pump in two different directions, namely a delivery direction and a return direction, if the top dead center of the pump can be precisely determined during its operation. For this purpose, a pump is provided, which has a diaphragm pump module that is fitted with at least one sensor. The sensor is fitted so as to detect the arrival at a top and/or bottom dead center of the diaphragm pump module. A method for determining a top and/or bottom dead center of the diaphragm pump module of the pump is also provided, wherein the top dead center is detected by means of the sensor. In particular the diaphragm pump takes the form of a reciprocating piston diaphragm pump, or a rotary diaphragm pump. In the case of a reciprocating piston diaphragm pump, the top dead center of the diaphragm pump module corresponds to the top dead center of its reciprocating piston, and the bottom dead center of the diaphragm pump module corresponds to the bottom dead center of its reciprocating piston. The sensor can be designed in different ways in different forms of embodiment of the pump and the method:

In one embodiment of the pump, provision is made for the sensor to be a microphone that is fitted so as to detect an impact noise of a diaphragm of the diaphragm pump module. Furthermore, a stop is provided in the diaphragm pump module, which is arranged in such a way that the diaphragm strikes it when the diaphragm pump module reaches its top dead center. When using a pump according to this embodiment, therefore, provision is made in the method for the top dead center to be identified when the microphone detects the impact noise.

In another embodiment of the pump, the sensor is a camera or a photodetector. If the sensor takes the form of a photodetector, a light source can also be provided. The camera or the photodetector is fitted so as to detect a position of the diaphragm of the diaphragm pump module. According to this embodiment, if a pump is used, the top dead center is identified in the method when the camera or the photodetector detects that the diaphragm has reached its top position. Here the top position is understood to be the position at which the diaphragm experiences its maximum deflection.

In a further embodiment of the pump, the sensor is a Hall effect sensor. This is fitted so as to measure a distance from the diaphragm of the diaphragm pump module. When using the pump according to this example of embodiment, the top dead center is identified when it is detected that the distance between the Hall effect sensor and the diaphragm assumes its minimum value.

In a further example of embodiment of the pump, the sensor is likewise a Hall effect sensor. However, this is fitted so as to measure an inhomogeneity in a magnetic field of the diaphragm pump module. For this purpose a standard Hall effect sensor of a motor controller of the diaphragm pump module can in general be used. However, the latter does not normally detect any inhomogeneities in the magnetic field. Such an inhomogeneity can be artificially generated by providing an inhomogeneity in a magnet of the diaphragm pump module. This is preferably aligned with the top or bottom dead center of the diaphragm pump module. When using a pump according to this embodiment, the top or bottom dead center is identified when the Hall effect sensor detects the occurrence of an inhomogeneity.

In a further embodiment of the pump, the sensor takes the form of a TRM (Tunnel Magneto Resistance) sensor. Moreover, in this embodiment of the pump an additional magnet is arranged in the diaphragm pump module. In particular, it is arranged on a motor shaft, and aligned with the top or bottom dead center of the diaphragm pump module. The TRM sensor is fitted so as to detect an angle of rotation of the magnet. If a pump according to this embodiment is used, the top or bottom dead center can be determined in the method from the angle of rotation of the magnet.

In different forms of embodiment of the invention the sensor can be arranged in a pump chamber of the pump, or in a working region of a magnetic armature of the pump.

If the top or bottom dead center is known, this enables, for example, an implementation of the pump in which the latter has an inlet and an outlet, wherein an inlet valve is arranged in the inlet and an outlet valve is arranged in the outlet. Each valve has a closure element, which is fitted so as to close the inlet or the outlet in a closure position. Furthermore, each valve has a restoring element, in particular in the form of a spring, which is fitted so as to push the closure element into the closure position by means of a restoring force. Finally, each valve has an actuator, which is fitted so as to move the closure element out of the closure position. When the actuator is actuated, it overcomes the restoring force, so that the inlet valve or outlet valve opens. When the actuation of the actuator is terminated, the restoring force pushes the respective closure element back into the closure position and the inlet valve or the outlet valve is once again closed.

Such a pump can be operated in a delivery mode of operation and a return mode of operation. In the delivery mode of operation, the inlet valve is opened and the outlet valve is closed, when the diaphragm pump module moves from the bottom dead center to the top dead center, and the inlet valve is closed and the outlet valve is opened, when the diaphragm pump module moves from the top dead center to the bottom dead center. In the return mode of operation, however, the inlet valve is closed and the outlet valve is opened, when the diaphragm pump module moves from the bottom dead center to the top dead center, and the inlet valve is opened and the outlet valve is closed, when the diaphragm pump module moves from the top dead center to the bottom dead center. This enables operation in both delivery and return modes of operation with a single pump, wherein valves are provided only in the inlet and the outlet of the pump, so that leakages can be minimized.

The computer program is equipped to execute each step of the method for determining the top and/or bottom dead center, and/or each step of the method for operating the pump, when executed on a computer or an electronic control unit. It enables the implementation of different forms of embodiment of the methods in an electronic control unit, without having to make structural changes to the latter. For this purpose it is stored on the machine-readable storage medium.

By uploading the computer program onto a conventional electronic control unit, the electronic control unit is obtained, which is equipped so as to determine a top and/or bottom dead center of a diaphragm pump module of a pump, and/or to operate a pump.

### BRIEF DESCRIPTION OF THE DRAWINGS

Examples of embodiment of the inventions are shown in drawings, and are explained in more detail in the following description.

FIG. 1 shows a cross-sectional representation of a pump according to an example of embodiment of the invention.

FIG. 2 shows a schematic representation of a pump according to an example of embodiment of the invention.

FIG. 3 shows a schematic representation of the pump, as shown in FIG. 2, in a first operating state.

FIG. 4 shows a schematic representation of a pump, as shown in FIG. 2, in a second operating state.

FIG. 5 shows a schematic representation of the pump, as shown in FIG. 2, in a third operating state.

FIG. 6 shows a schematic representation of the pump, as shown in FIG. 2, in a fourth operating state.

FIG. 7 shows a diagram of the time profile of the deflection of a reciprocating piston of a pump according to an example of embodiment of the invention, together with the activation of its inlet valve and its outlet valve.

FIG. 8 shows a schematic cross-sectional representation of the diaphragm pump module of a pump according to an example of embodiment of the invention.

FIG. 9 shows a schematic cross-sectional representation of a diaphragm pump module of a pump according to another example of embodiment of the invention.

FIG. 10 shows a schematic cross-sectional representation of a diaphragm pump module of a pump according to a further example of embodiment of the invention.

FIG. 11 shows a schematic cross-sectional representation of a diaphragm pump module of a pump according to a further example of embodiment of the invention.

FIG. 12 shows a schematic cross-sectional representation of a diaphragm pump module of a pump according to a further example of embodiment of the invention.

### DETAILED DESCRIPTION

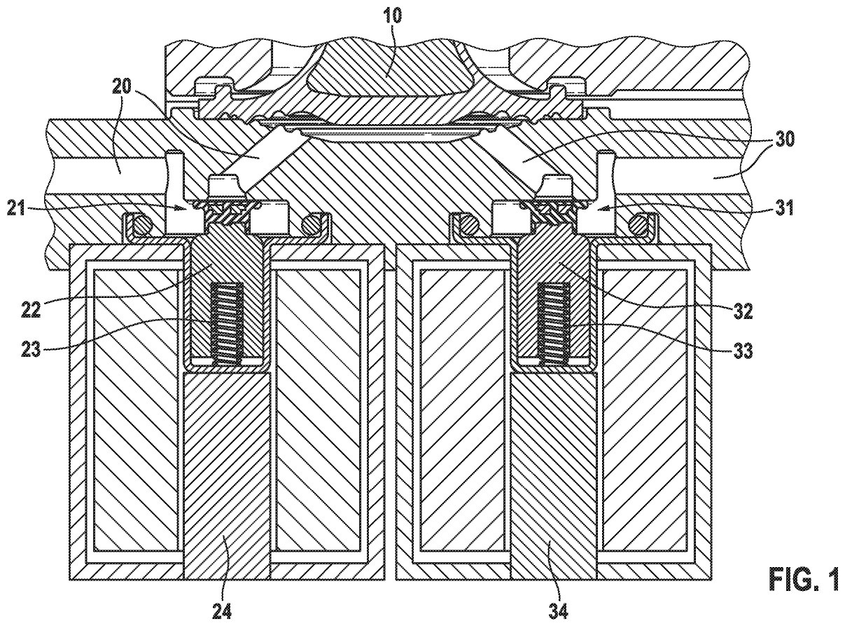

In the following examples of embodiment of pumps as presented, these, as shown in FIG. 1, have a diaphragm pump module 10 with an inlet 20 and an outlet 30. The diaphragm pump module is embodied as a reciprocating piston diaphragm pump module of a reciprocating piston diaphragm pump. An inlet valve 21 is arranged in the inlet 20. This has a closure element 22, which is pushed into the inlet 20 by the restoring element 23 in the form of a spring, in such a way that it closes the inlet. An actuator 24, which can be electrically activated, is fitted so as to retract the closure element 22 against the restoring force of the spring so that the inlet 20 is opened. When the power supply to the actuator 24 terminates, the restoring element 23 pushes the closure element 22 back into the inlet 20 so that the latter is closed once again. In the same way, an outlet valve 31 is arranged in the outlet 30. This has a closure element 32, which is pressed into the outlet 30 by means of a restoring element 33 in the form of a spring. An actuator 34, which can be electrically activated, is fitted so as to open the outlet valve 31 by pulling back the closure element 32. When the power supply to this actuator 34 terminates, the outlet valve 31 is closed once again.

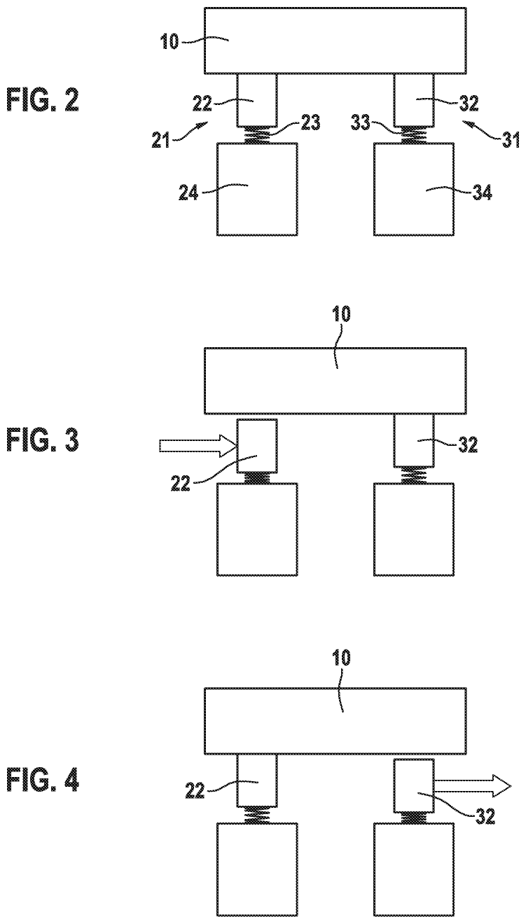

FIG. 2 shows a schematic representation of the components described above. Here both valves 21, 31 are closed. FIGS. 3 to 6 show how the flow of a liquid, such as an aqueous urea solution, can be controlled by the pump, in each case by opening one of the valves 21, 31 and closing the other. As shown in FIG. 7, this opening and closing must be synchronized with the movement of a reciprocating piston of the diaphragm pump module 10. Its deflection co changes sinusoidally between a bottom dead center UT and a top dead center OT. The activation A is also indicated with the time t of the valves 21, 31, wherein A=0 corresponds to a switched-off actuator 24, 34, and A=1 corresponds to a switched-on actuator 24, 34. This activation A is specified as an activation A₂₁ for the inlet valve 21, and A₃₁ for the outlet valve 31. The inlet valve 21 is open during the time period t₂₁+ and closed during the time period t₂₁−. The outlet valve 31 is open during the time period t₃₁+ and closed during the time period t₃₁−. The opening process is preceded by a suction delay time tₛ. The inlet valve 21 is then opened, resulting in the state shown in FIG. 3. The reciprocating piston moves from its bottom dead center UT to its top dead center OT, and liquid is sucked into the diaphragm pump module 10. The power supply to the actuator 24 of the inlet valve 21 is terminated at the top dead center OT. After a pressure delay time tₚ starting from the bottom dead center UT has elapsed, the outlet valve 31 is opened, while the inlet valve 21 closes. Until the bottom dead center UT is reached, the state shown in FIG. 4 now prevails, so that the liquid can leave the diaphragm pump module 10 through the outlet 30.

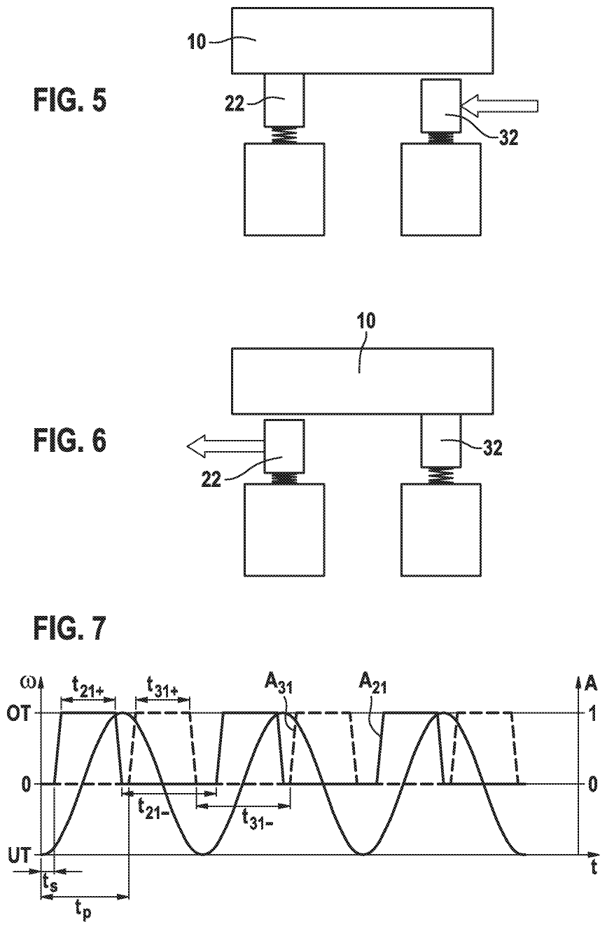

If, in FIG. 7, the actuation A₂₁ of the inlet valve 21 is interchanged with the actuation A₃₁ of the outlet valve 31, the pump can be operated in the return mode of operation. In a state as shown in FIG. 5, with the outlet valve 31 open and the inlet valve 21 closed, liquid then flows into the diaphragm pump module 10, and can leave the diaphragm pump module 10 again through the inlet 20 in the state as shown in FIG. 6, with the outlet valve 31 closed and the inlet valve 21 open.

The determination of the top dead center OT required for the execution of the delivery and return modes of operation is implemented in different examples of embodiment of the pump by using different sensors:

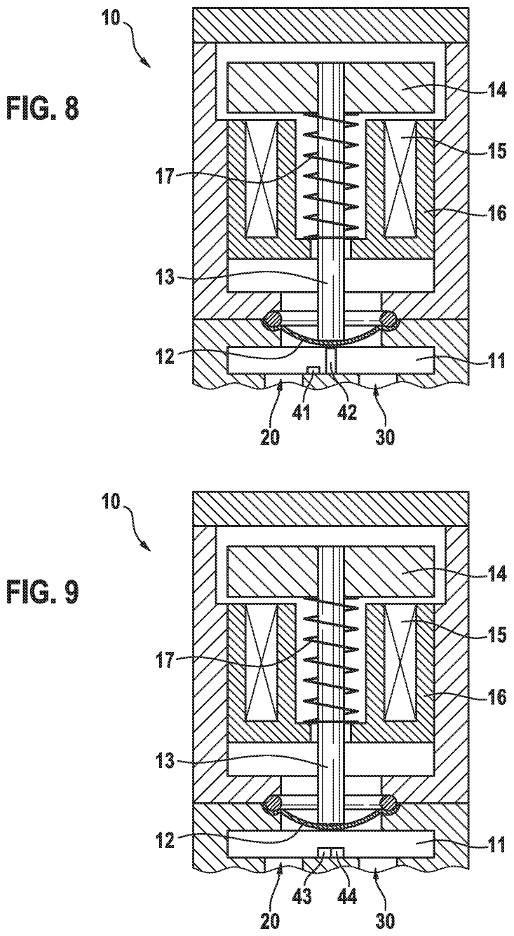

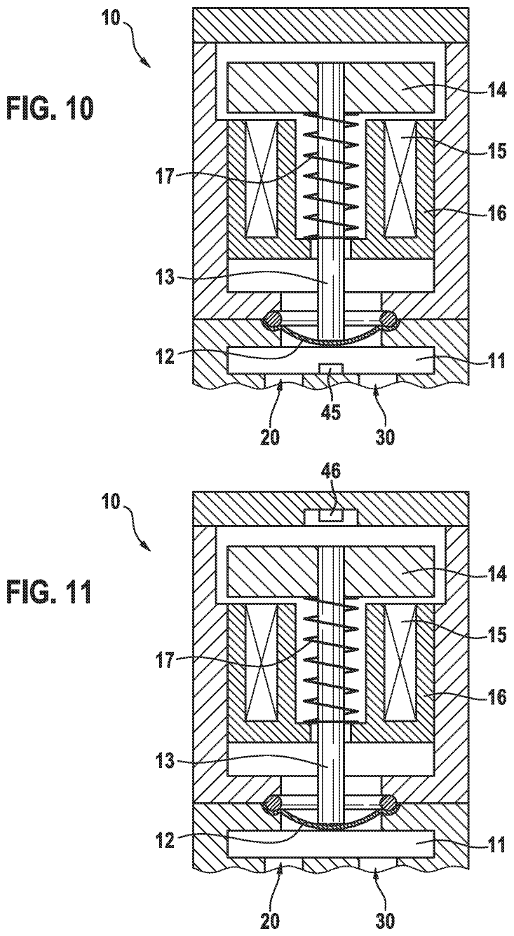

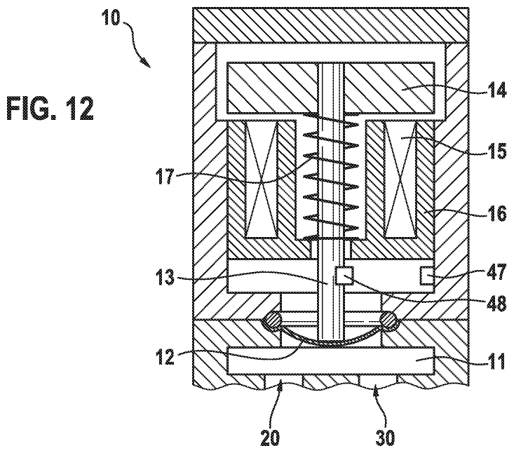

In the first example of embodiment, as shown in FIG. 8, the diaphragm pump module 10 has a diaphragm working chamber 11 into which the inlet 20 and the outlet 30 flow. This is bounded by a diaphragm 12, which is connected to the reciprocating piston 13 and is moved by means of the latter. The reciprocating piston 13 has a magnetic armature 14, which is moved within a solenoid 16 by the generation of a magnetic field by an annular coil 15. In its rest position, the magnetic armature 14 with the reciprocating piston 13 is preloaded by the stress of a coil spring 17. The first example of embodiment provides for a microphone 41 to be arranged in the diaphragm working chamber 11. A stop 42 is also arranged there, which is positioned in such a way that the diaphragm 12 strikes it when the reciprocating piston 13 reaches its top dead center OT. This noise is detected by the microphone 41, and the top dead center OT is thereby identified.

In a second example of embodiment, which is shown in FIG. 9, a sensor 43 in the form of a photodetector is arranged in the diaphragm working chamber 11. A light source 44 is also arranged there, which irradiates the diaphragm 12. From the light reflected by the diaphragm 12 from the light source 44, the photodetector 43 can detect the arrival at the top dead center OT of the reciprocating piston 13.

In the third example of embodiment, a Hall effect sensor 45 is arranged in the diaphragm working chamber 11. This continuously measures its distance to the diaphragm 12. When this distance reaches a minimum, the arrival at the top dead center is identified.

In a fourth example of embodiment of the pump, the diaphragm pump module 10 also features a Hall effect sensor. However, this Hall effect sensor 46 is not located in the diaphragm working chamber 11. Instead, it is positioned in such a way that it can identify an inhomogeneity in the magnetic field of the diaphragm pump module 10. The solenoid 16 is embodied such that this inhomogeneity occurs when the reciprocating piston 13 reaches its top dead center OT. In this way, the top dead center can be inferred from the signal of the Hall effect sensor 46.

In a fifth example of embodiment of the pump, the latter has a TMR sensor 47. In addition, another magnet 48 is arranged in such a way that its position alters as a result of the movement of the reciprocating piston 13. This results in an angle of rotation that can be detected by means of the TMR sensor 47. This arrangement is designed in such a way that the arrival at the top dead center OT can be determined from the angle of rotation by means of the TMR sensor.

1. A pump having a diaphragm pump module (10), which has at least one sensor (41, 44, 45, 46, 47) configured to detect an arrival at a top dead center (OT) and/or bottom dead center (UT) of the diaphragm pump module (10).

2. The pump according to claim 1, characterized in that the sensor (41) is a microphone configured to detect an impact noise that is caused by a diaphragm (12) of the diaphragm pump module (10), when the diaphragm strikes a stop (42).

3. The pump according to claim 1, characterized in that the sensor (43) is a camera or a photodetector configured to detect a position of a diaphragm (12) of the diaphragm pump module (10).

4. The pump according to claim 1, characterized in that the sensor (45) is a Hall effect sensor configured to measure a distance from a diaphragm (12) of the diaphragm pump module (10).

5. The pump according to claim 1, characterized in that the sensor (46) is a Hall effect sensor configured to measure an inhomogeneity in a magnetic field in the diaphragm pump module (10).

6. The pump according to claim 1, characterized in that the sensor (47) is a TMR sensor configured to detect an angle of rotation of a magnet (48), which is arranged in the diaphragm pump module (10).

7. The pump according to claim 1, wherein the pump has an inlet (20) and an outlet (30), wherein an inlet valve (21) is arranged in the inlet (20), and an outlet valve (31) is arranged in the outlet (30), and each valve (21, 31) has a closure element (22, 32), which is fitted so as to close the inlet (20) or the outlet (30) in a closure position, wherein the pump has a restoring element (23, 33), which is fitted so as to push the closure element (22, 32) into the closure position by means of a restoring force, and wherein the pump has an actuator (24, 34), which is fitted so as to move the closure element (22, 32) out of the closure position.

8. A method for determining a top dead center (OT) and/or bottom dead center (UT) of a diaphragm pump module (10) of a pump according to claim 1, wherein the top dead center (OT) is detected by the sensor (41, 44, 45, 46, 47).

9. The method according to claim 8, characterized in that the sensor (41) is a microphone configured to detect an impact noise that is caused by a diaphragm (12) of the diaphragm pump module (10), when the diaphragm strikes a stop (42), and the top dead center is identified when the microphone detects the impact noise.

10. The method according to claim 8, characterized in that the sensor (43) is a camera or a photodetector configured to detect a position of a diaphragm (12) of the diaphragm pump module (10), and the top dead center is identified when the camera or the photodetector detects that the diaphragm has reached its top position.

11. The method according to claim 8, characterized in that the sensor (45) is a Hall effect sensor configured to measure a distance from a diaphragm (12) of the diaphragm pump module (10), and the top dead center is identified when the distance between the Hall effect sensor and the diaphragm assumes a minimum value.

12. The method according to claim 8, characterized in that the sensor (46) is a Hall effect sensor configured to measure an inhomogeneity in a magnetic field in the diaphragm pump module (10), and the top dead center is identified when the Hall effect sensor detects the occurrence of the inhomogeneity.

13. The method according to claim 8, characterized in that the sensor (47) is a TMR sensor configured to detect an angle of rotation of a magnet (48), which is arranged in the diaphragm pump module (10), and the top dead center is determined from the angle of rotation of the magnet.

14. A method for operating a pump according to claim 7, wherein
in a delivery mode of operation, the inlet valve (21) is opened and the outlet valve (31) is closed, when the diaphragm pump module (10) moves from the bottom dead center (UT) to the top dead center (OT), and the inlet valve (21) is closed and the outlet valve (31) is opened, when the diaphragm pump module (10) moves from the top dead center (OT) to the bottom dead center (UT),
in a return mode of operation, the inlet valve (21) is closed and the outlet valve (31) is opened, when the diaphragm pump module (10) moves from the bottom dead center (UT) to the top dead center (OT), and the inlet valve (21) is opened and the outlet valve (31) is closed, when the diaphragm pump module (10) moves from the top dead center (OT) to the bottom dead center (UT); and
wherein the top dead center is determined by the sensor (41, 44, 45, 46, 47).

15. A non-transitory computer-readable storage medium, storing instructions that when executed by a computer cause the computer to determine a top dead center (OT) and/or bottom dead center (UT) of a diaphragm pump module (10) based on information received from at least one sensor (41, 44, 45, 46, 47) configured to detect an arrival at a top dead center (OT) and/or bottom dead center (UT) of the diaphragm pump module (10).

16. An electronic control unit configured to determine a top dead center (OT) and/or bottom dead center (UT) of a diaphragm pump module (10) of a pump, the electronic control unit comprising:
a computer configured to determine top dead center (OT) and/or bottom dead center (UT) of the diaphragm pump module (10) based on information received from at least one sensor (41, 44, 45, 46, 47) configured to detect an arrival at top dead center (OT) and/or bottom dead center (UT) of the diaphragm pump module (10.

17. An electronic control unit configured to operate a pump, the electronic control unit including a computer configured to
in a delivery mode of operation,
when a diaphragm pump module (10) moves from bottom dead center (UT) to top dead center (OT), cause an inlet valve (21) to open and an outlet valve (31) to close, and
when the diaphragm pump module (10) moves from top dead center (OT) to bottom dead center (UT), cause the inlet valve (21) to close and the outlet valve (31) to open, and
in a return mode of operation,
when the diaphragm pump module (10) moves from bottom dead center (UT) to top dead center (OT), the inlet valve (21) is closed and the outlet valve (31) is opened, and
when the diaphragm pump module (10) moves from top dead center (OT) to bottom dead center (UT); the inlet valve (21) is opened and the outlet valve (31) is closed, and
wherein the electronic control unit is configured to be connected to a sensor (41, 44, 45, 46, 47) for determining top dead center.
